(19) United States
(12) Patent Application Publication
(10) Pub. No.: US 2010/0153290 A1
(43) Pub. Date: Jun. 17, 2010

(54) Methods of matching job profiles and candidate profiles

(76) Inventor: Paul Duggan, London (GB)

Correspondence Address: MANELLI DENISON & SELTER PLLC;7th Floor, 2000 M Street, N.W., Washington, DC, 20036-3307, US

(21) Appl. No.: 12/314,550

(22) Filed: Dec. 12, 2008

(51) Int. Cl. G06Q 99/00

(52) U.S. Cl. 705/321

(57) ABSTRACT

Methods and computer program products are described for matching candidate profiles and job profiles during a job search or a people search. Methods of matching of a candidate profile with a plurality of job profiles, or a job profile with a plurality of candidate profiles are disclosed. During the disclosed methods a strict initial match between a candidate profile and a plurality of job profiles, or between a job profile and a candidate profile is initially undertaken in order to select matched profiles. Thereafter a fuzzy match between the candidate profile and the matched job profiles, or between a job profile and the matched candidate profile based on the degree of similarity between the respective profiles is used to determine the relevance of the matched profiles. A job or candidate profile and/or a matched job or candidate profile may be forwarded using a social network. The profiles preferably include psychometric information or criteria.

### FIELD OF THE INVENTION

This invention relates to improvements in methods of matching job profiles and candidate profiles. The invention is particularly relevant to the field of on-line recruitment.

### BACKGROUND OF THE INVENTION

In the field of recruitment it is necessary to identify which candidates are most suited for a particular role and/or which roles are available for a particular candidate.

In recent years computer-implemented methods of automatically matching candidates and roles have been developed. In particular as information regarding the available candidates and jobs are held on computer systems, it is desirable to provide efficient and effective methods of identifying suitable candidates or suitable roles.

### PRIOR ART

US2002002479 A1 relates to a career management system that provides a method of job placement. The disclosed method includes storing a database including a plurality of records of worker profiles, providing a description of a job opening, storing the description of the job opening in a job opening database, and automatically determining by a processor, for at least one of the records in the worker database, whether the worker profile in the record matches the description of the job opening.

U.S. Pat. No. 6,272,467 relates to an automated method for identifying matches between a set of predetermined traits and a set of preferences. This method can be used to find compatible matches in a variety of situations where participants are identified by a profile of traits and a set of criteria desired in at match, including, for example, and matching job hunters with employment opportunities. In the method disclosed in this document selected preferences in each profile are compared with the traits of other profile in a database of profiles to eliminate incompatible profiles. A compatibility score for each remaining compared profile is generated based on a comparison of selected preferences in each profile with the traits of each other profile to identify a plurality of matched profiles and the matched profiles are then sorted according to the compatibility score, and the results reported to the user.

### SUMMARY OF THE INVENTION

According to the present invention there is provided a computer-implemented method of matching a job profile, having an associated full text jobs index, with a candidate profile, having an associated candidate full text digest, comprising the steps of: comparing a plurality of job profiles with a candidate profile to determine one or more matches; determining, for the or each job profile matched with the candidate profile, the degree of matching between the candidate full text digest and the respective full text jobs index; and providing information relating to at least one job profile matched to the candidate profile together with information relating to the degree of matching.

According to another aspect of the invention there is provided a computer-implemented method of matching a candidate profile, having an associated candidate full text digest, with a job profile, having an associated full text jobs index, comprising the steps of: comparing a plurality of candidate profiles with a job profile to determine one or more matches; determining, for the or each candidate profile matched with the job profile, the degree of matching between the full text jobs index and the respective candidate full text digest; and providing information relating to at least one candidate profile matched to the job profile together with information relating to the degree of matching.

In accordance with another aspect of the invention there is provided a computer program product residing on a computer readable medium having a plurality of instructions stored thereon which, when executed by a processor, cause the processor to perform operations comprising the method as claimed in claim 13.

The invention will now be described, by way of example only, with reference to the accompanying drawings, in which:-

### BRIEF DESCRIPTION OF THE DRAWINGS

FIG. 1 is a high level block diagram of an embodiment of the invention.

FIG. 2 shows a typical apparatus that may be used to implement an embodiment of the invention.

FIG. 3a is an exemplary functional diagram of a candidate profile record 12a

FIG. 3b is an exemplary functional diagram of a job profile record 12b.

FIG. 4 relates to a job matching method in accordance with an embodiment of the invention.

FIG. 5 relates to a job searching method in accordance with an embodiment of the invention.

FIG. 6 relates to a people matching method in accordance with an embodiment of the invention.

FIG. 7 relate to a people searching method in accordance with an embodiment of the invention.

### DETAILED DESCRIPTION OF THE ILLUSTRATED EMBODIMENT

The invention has been described by way of example with reference to the accompanying drawings.

FIG. 1 is a high level block diagram of an embodiment of the invention. In the exemplary embodiment shown in FIG. 1, the invention comprises an input operation element 2, a filter operation element 4, a digest operation element 6, a matching operation element 8 and an output operation element 10, for inputting, selecting and matching profiles 12, and for outputting the resulting matches to a display 14 and/or to a social network 16. In addition a user access element 18 is provided for inputting information and controlling the output of information from the system.

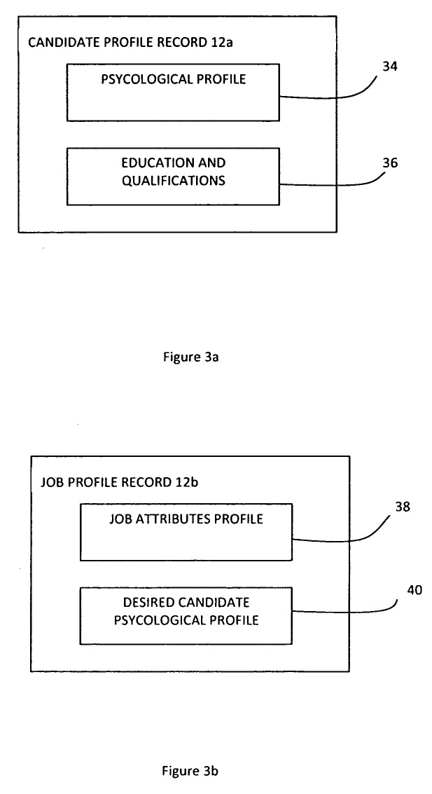

The input operation element 4 is provided for enabling the creation of new candidate profiles 12a or new job profiles 12b in response to information provided by the user via the user access element 18. These profiles will be described in more detail with reference to FIGS. 3a and 3b. Typically the user might create or provide information to complete a job search form containing information relating to a desired job and information relating to the candidate. Alternatively, the user might create or provide information to complete a candidate search form containing information relating to desired candidate attributes for a job. Input element 2 creates candidate profiles 12a or job profiles 12b in response to the information received.

The filter operation element 4 is provided for filtering the candidate profiles 12a with respect to a search job profile 12b during a candidate search operation or for filtering the job profiles 12b with respect to a search candidate profile 12a during a job search operation in order to determine matches, and provides information relating to the matched profiles to the digest operation element 6. The filter operation element 4 may carry out the filtering process in response to a search operation initiated by the input of a profile by a user via the user access operation element 18, or in response to a match operation for existing profiles 12 initiated directly by a user (not shown in FIG. 1). The operation of the filter operation element 4 will be described hereafter.

The digest operation element 6 builds a full text digest (not shown in FIG. 1) of the search candidate profile 12a or the search job profile 12b and provides the full text digest to the match operation element 8. In the exemplary embodiment the full text digest is built from the corresponding search candidate profile 12a or the search job profile 12b. However, in other embodiments of the invention (not shown) the full text digest may be built directly from search criteria or other information created or provided by the user, for example during completion of the candidate search form or the job search form.

In addition, in the exemplary embodiment shown in FIG. 1, the digest operation 6 also builds a full text jobs index or a full text people index (not shown in FIG. 1) corresponding to the matched or selected profiles identified by the filter operation element 4 and provides the full text jobs index or the full text people index to the matching operation element 8. In alternative embodiments (also not shown in FIG. 1), full text indexes corresponding to a job profile or to a candidate profile may be created, for example as part of the process in the input operation element 2 when the profile is originally created, or by a dedicated index operation element (not shown in FIG. 1) and the match operation element 8 may access the full text index corresponding to the selected profiles identified by the filter operation element 4.

The match operation element 8 matches the full text digest of the search candidate profile 12a or the search job profile 12b received from the digest operation element 6 with the full text jobs index or a full text people index corresponding to the matched or selected profiles identified by the filter operation element 4 to determine the degree of matching between a candidate and a job. In the exemplary embodiment, the match operation element 8 also orders the matched or selected profiles in accordance with the degree of match between the full text digest of the search candidate profile 12a or the search job profile 12b and the respective full text jobs index or full text people index, and provides the ordered list to the output operation element 10.

The output operation element 10 can output the ordered list received from the match operation element 8 either to the display 14 or a social network 16 under control of the user access operation element 18.

In addition, in some embodiments not shown in FIG. 1, the output operation element 8 may access the profiles 12 directly under the control of the user access operation element 18, to enable display of a profile 12 on display 14 and/or the forwarding of a profile 12 to contacts in the social network 16. Thus, in embodiments of the invention, the user can cause the output operation element 8, under the control of the user access operation element 18 to forward all or any one of the ordered matched job profiles and/or a candidate profile to one or more contacts in the social network 16. Thus a user is able to refer to a social contact a job opening which they believe to be of interest to that social contact.

In embodiments of the invention, the user can apply for a job opening by submitting a candidate profile, with or without a conventional Curriculum Vitae or Resume, to a potential employer, for example in respect of a job identified in a matched job profile.

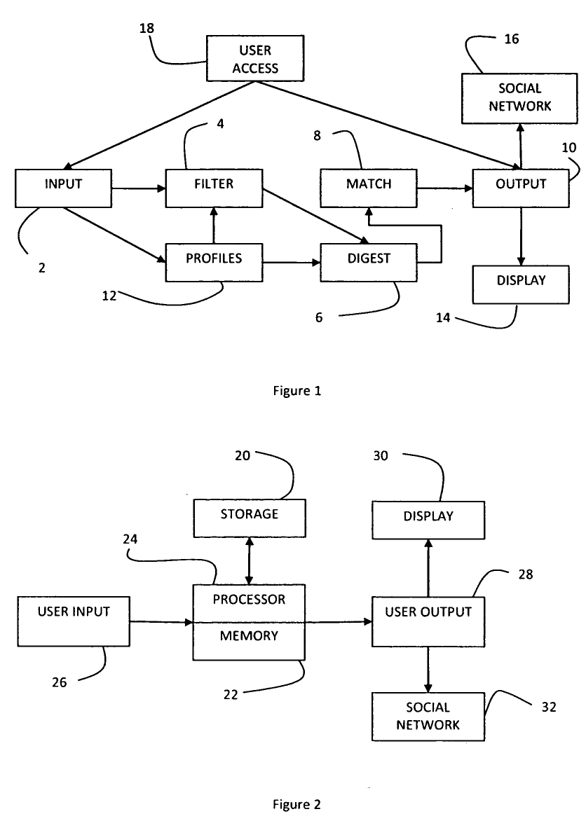

FIG. 2 shows a typical apparatus that may be used to implement an embodiment of the invention. In the exemplary embodiment, the profiles 12, full text indexes and full text digests are stored as database records in storage 20, and the input operation element 2, filter operation element 4, digest operation element 6, matching operation element 8 and output operation element are implemented as a computer program elements in a computer program stored in memory 22 and running on processor 24. The invention may be implemented using a wide variety of existing programming languages and, if used, a wide variety of database programs. The software embodying the method is transportable to a variety of computer systems, for example but not limited to personal computers, laptop computers, notebook computer, mainframes and mini-computers. The computer system may act as a server computer for a web-based system in embodiments of the invention.

Storage 20 may include, but is not limited to a hard disc drive, a tape drive, an optical drive, a RAID array, Random Access Memory RAM), a Compact Flash (CF) storage device, and a memory stick storage device.

User access element 18 of FIG. 1 is provided by the user input 26 and user output 28 of FIG. 2. In the exemplary embodiment user input 26 and user output 28 are provided by a web-based access system allowing remote users to interact with the system. The web-based system may utilise a network operating system, examples of which include but are not limited to Microsoft IIS, Novell Webserver or Apache Webserver that allows for HTTP access to a server computer as discussed above. In embodiments of the invention user access element 18 may be a client-side application that resides on a client side computer connected by a network, such as the Internet, to the computer system on which the computer program incorporating the main operational elements resides. However, other means for enabling user access to the system can be envisaged, and are intended to be encompassed by the present invention.

In some embodiments of the invention user output 28 can output results (for example an ordered list of matching profiles) to a display 30 or to a social network 32. In this context, social network 32 means any network reflecting social relationships, and includes, without limitation, online social networks (for example Facebook™, Linkedin™ and MySpace™, online email accounts (for example Gmail™ and Hotmail™), and contacts held in other electronic forms outside of the internet (for example Microsoft Outlook™). In particular it should be noted that the social network of the present invention is intended to include business network contacts as well as friends and family. Thus a recruitment agency list of client contacts, for example, would be a social network.

FIG. 3a is an exemplary functional diagram of a candidate profile record 12a and FIG. 3b is an exemplary functional diagram of a job profile record 12b.

Referring to FIG. 3a, the exemplary candidate profile record 12a comprises a psychological profile sub-record 34 and an education and qualifications profile sub-record 36, and therefore contains information on the attributes of a candidate.

Referring to FIG. 3b, the exemplary job profile record 12b comprises a job attributes profile sub-record 38, together with a candidate desired psychological profile sub-record 40, and therefore contains information on the attributes of a job.

In the exemplary embodiment the psychological profile sub-record 34 and the candidate desired psychological profile sub-record 40 typically will include a variety of psychological information useful in describing candidates distinguishing between the suitability of candidates for a job or role.

In the exemplary embodiment the education and qualifications profile sub-record 36 and the job attributes profile sub-record 38 will include a variety of information useful to describe a job and suitable to evaluate a candidates suitability for the role. For example, this might include information relating to job title, description of the role, salary expectation, and qualification or education levels required.

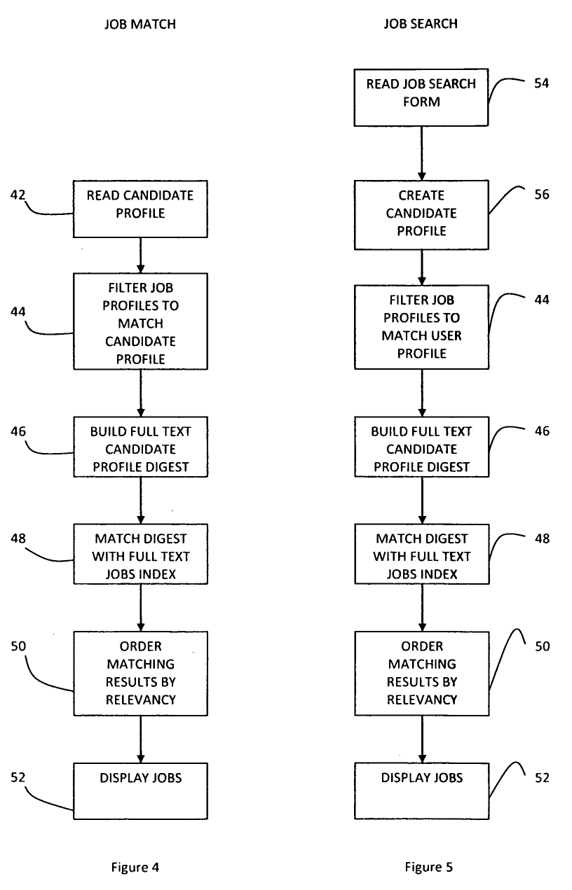

Methods in accordance with the invention will now be described with reference to FIGS. 4-7. In these Figures, the same or similar method steps have been assigned the same or similar reference numerals.

FIGS. 4 and 5 relate to a job matching method and a job searching method in accordance with embodiments of the invention. These methods can be used to identify suitable jobs or roles represented by a stored job profile. Typically these methods might be used by a candidate, or on behalf of a candidate, to identify suitable openings. The job match method set out in FIG. 4 is used when a candidate profile has already been created and stored in the system in accordance with the exemplary embodiment, in order to match the candidate profile with job profiles. The job search method set out in FIG. 5 is used when a candidate profile is to be created.

In the job matching method as set out in FIG. 4, first in step 42 a candidate profile 12a is read by the filter operation element 4, and the filter operation element 4 filters job profiles 12b that match the candidate profile 12a in step 44. In the exemplary embodiment of the invention, a strict match is required between the sub-records of the candidate profile 12a and the job profiles in order to determine a match. In this way, factual job information as well as psychological information with regard to a candidate and a job opening are taken into account when determining a match.

Next a full text candidate profile digest is built in step 46. In the present invention the digest operation element 6 builds the full text digest of the search candidate profile 12a.

Next the full text candidate profile digest is matched by the matching operation element 8 against the full text jobs index for the job profiles selected by the filter operation element 4. This matching is a “fuzzy” matching and thus a match of at least one word is required in order to generate a match at this stage. The more words in common between the full text candidate profile digest and the full text job index for a particular job profile, the higher the match rating assigned to that job profile.

The matching operation element 8 then orders the jobs identified in step 44 by the filter operation element 4 in accordance with the match rating assigned to that job profile in step 50.

In the exemplary embodiment, in step 52 the ordered matched job profiles are displayed on the display 14 by the output operation element 10. The user may then clearly see the selected matched jobs and also the degree to which the jobs match the candidate profile

FIG. 5 relates to an exemplary job search method which, as indicated above, is used when a candidate profile is to be created. Thus in the exemplary job search method the system user uses the user access element 18 to access a job search form provided by the input operation element and to provide relevant information in step 54. The input operation element 2 then creates a candidate profile 12a from the information supplied and stores the candidate profile in the storage 20 in step 56. Thereafter, the steps of the exemplary job search method correspond with the steps 44-52 previously described with reference to FIG. 4, and further description thereof will therefore be omitted.

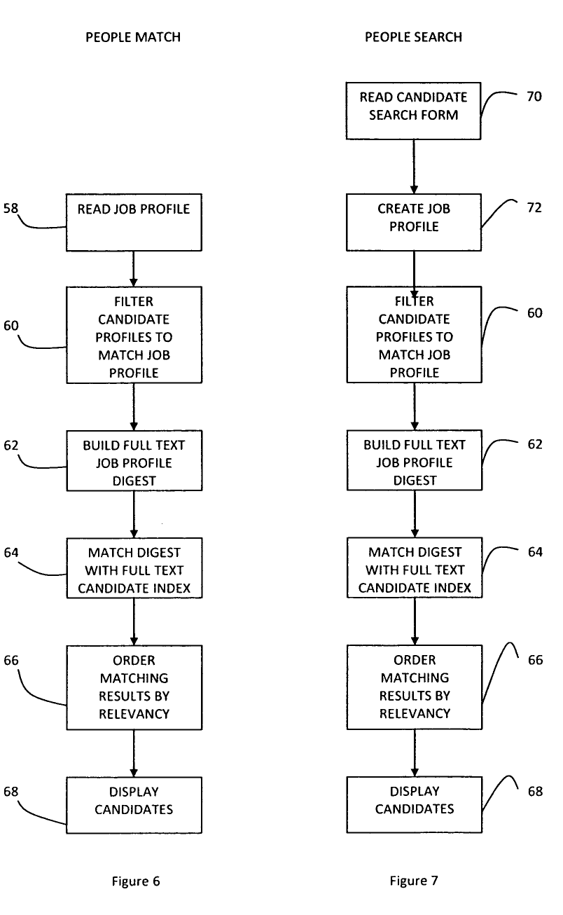

FIGS. 6 and 7 relate to a people matching method and a people searching method in accordance with embodiments of the invention. These methods can be used to identify suitable candidates represented by a stored candidate profile. Typically these methods might be used by an employer or recruiter, to identify suitable candidates. The people match method set out in FIG. 6 is used when a job profile has already been created and stored in the system in accordance with the exemplary embodiment, in order to match the job profile with candidate profiles. The people search method set out in FIG. 7 is used when a job profile is to be created.

In the people match method as set out in FIG. 4, first in step 58 a job profile 12b is read by the filter operation element 4. The filter operation element 4 filters candidate profiles 12a to identify those that match the job profile 12b in step 60. In the exemplary embodiment of the invention, a strict match is required between the sub-records of the job profile 12b and the candidate profiles in order to determine a match. In this way, factual job information as well as psychological information with regard to a candidate and a job opening are taken into account when determining a match.

Next a full text job profile digest is built in step 62. In the present invention the digest operation element 6 builds the full text digest of the job profile 12b.

Next the full text job profile digest is matched by the matching operation element 8 against a full text candidate index for the candidate profiles selected by the filter operation element 4 in step 64. This matching is a “fuzzy” matching and thus a match of at least one word is required in order to generate a match at this stage. The more words in common between the full text candidate profile digest and the full text job index for a particular candidate profile, the higher the match rating assigned to that candidate profile.

The matching operation element 8 then orders the candidate profiles identified in step 60 by the filter operation element 4 in accordance with the match rating assigned to that job profile in step 66.

In the exemplary embodiment, in step 68 the ordered matched candidate profiles are displayed on the display 14 by the output operation element 10.

FIG. 7 relates to an exemplary people search method which, as indicated above, is used when a job profile is to be created.

Thus in the exemplary candidate search method the system user uses the user access element 18 to access a candidate search form provided by the input operation element 2 and to provide relevant information in step 70. The candidate search form may include in embodiments of the invention information for a psychometric profile for the role they are looking to fill or advertise for. In addition the users may include details including but not limited to outlining the experience, location, salary, benefits and psychometric profile for the role.

The input operation element 2 then creates a job profile 12b from the information supplied and stores the job profile in the storage 20 in step 72.

Thereafter, the steps of the exemplary people search method correspond with the steps 60-68 previously described with reference to FIG. 6, and further description thereof will therefore be omitted.

In addition in some embodiments of the invention means are allowed to enable employers/recruiters to ask a series of qualifying questions to further validate and filter applicants in terms of their suitability for the role

Embodiments of the above described invention enable at least one or more of the following features in a recruitment system:
Allow candidates to manually search for jobs based on the extent to which their psychometric and experience matches to a series of jobs and rank the resulting job matches based on the completeness of the match on hierarchical 0-100% scale using the job search method described above with reference to FIG. 5.
Programmatically & automatically present candidates with job advertisements based on the candidates psychometric and experience match level and rank the resulting job advertisement matches based on a the completeness of the match on hierarchical 0-100% scale, using the job match method described above with reference to FIG. 4
Allow candidates to contact their currently existing contact networks, in a multitude of forms including but not limited to contacts held in their online social networks (for example facebook, linkedin and myspace), contacts held in their online email accounts (for example Gmail and Hotmail), and contacts held in other electronic forms outside of the internet (for example Microsoft Outlook) and present these contacts with their profile incorporating their psychometric profile and experience.
Allow candidates who have found a role of interest to attach their candidate profile including their psychometric and experience profile and apply directly for the role.
Allow candidates who have found a role of interest to attach their physical CV along with their candidate profile including their psychometric and experience profile and apply directly for the role.
Allow candidates having found a role they believe to be of interest to a person or people within their existing contact networks, in a multitude of forms including but not limited to contacts held in their online social networks (for example facebook, linkedin and myspace), contacts held in their online email accounts (for example Gmail and Hotmail), and contacts held in other electronic forms outside of the internet (for example Microsoft Outlook) to refer the job to these contacts.
Allow employers and recruiters to create a psychometric profile for the role they are looking to fill or advertise for.
Allow employers and recruiters to advertise jobs they are looking to fill, including but not limited to outlining the experience, location, salary, benefits and psychometric profile for the role they are advertising.
In addition allowing the employers/recruiters to ask a series of qualifying questions to further validate and filter applicants in terms of their suitability for the role.
Allow employers and recruiters to manually search for candidates based on their psychometric and experience match level to the job being offered and rank the resulting candidates matched based on a the completeness of the match on hierarchical 0-100% scale using the people search method described above with reference to FIG. 7.
Programmatically & automatically present employers and recruiters with potential candidates based on the match level of candidates' psychometric and experience and rank the resulting potential candidate matches based on a the completeness of the match on hierarchical 0-100% scale using the people match method described above with reference to FIG. 6.
Allow employers and recruiters to distribute a job advertisement, including a psychometric profile by posting it to a website.
Allow employers and recruiters to distribute a job advertisement, including a psychometric profile to their existing employees and contact networks in a multitude of forms including but not limited to contacts held in their companies employee database, contacts held in either company or individual employee/recruiter online social networks (for example facebook, linkedin and myspace), contacts held in either company or individual employee/recruiter online email accounts (for example Gmail and Hotmail), and either company or individual employee/recruiter contacts held in other electronic forms outside of the internet (for example Microsoft Outlook)
Further to allow employees be able to utilise their contact networks to refer jobs onward.

At least some embodiments of the present invention provide a process for the joining together psychometric profiling with social networking in the field of online recruitment. These embodiments overcome problems associated with effectively matching a candidate to a role.

1. A computer-implemented method of matching a job profile including therein psychometric profile data regarding the desired prospective candidate, the job profile having an associated full text jobs index, with a candidate profile including therein psychometric profile data relating to the candidate, the candidate profile having an associated candidate full text digest, comprising the steps of:
comparing a plurality of job profiles with a candidate profile to determine one or more matches;
determining, for the or each job profile matched with the candidate profile, the degree of matching between the candidate full text digest and the respective full text jobs index; and
providing information relating to at least one job profile matched to the candidate profile together with information relating to the degree of matching.

2. The method as claimed in claim 1 further comprising: the step of receiving job search information from a prospective candidate; and the step of extracting data included in a candidate profile therefrom.

3. The method as claimed in claim 2 further comprising the step of generating a candidate full text digest based on the job search information.

4. The method as claimed in claim 1 further comprising the step of generating a candidate full text digest based on the candidate profile.

5. The method as claimed in claim 1 further comprising the step of generating a job full text index based on the respective job profile.

6. The method as claimed in claim 1 further comprising the step of ordering the matched job profiles by degree of matching.

7. The method as claimed in claim 6, wherein the step of providing information relating to the matched jobs comprises providing the matched jobs ordered in accordance with the degree of matching.

8. The method as claimed in claim 1 wherein the step of providing information comprises the step of displaying information on a display.

9. The method as claimed in claim 1 further comprising the step of referring a job profile and/or a candidate profile used in or resulting from the method as claimed in claim 1 to at least one social network contact.

10. The method as claimed in claim 1 wherein the job profile also includes factual job data.

11. The method as claimed in claim 1 where the candidate profile also includes factual job data regarding a desired prospective job.

12. A computer program product residing on a computer readable medium having a plurality of instructions stored thereon which, when executed by a processor, cause the processor to perform operations comprising the method as claimed in claim 1.

13. A computer-implemented method of matching a candidate profile including therein psychometric profile data relating to the candidate, the candidate profile having an associated candidate full text digest, with a job profile including therein psychometric profile data regarding the desired prospective candidate, the job profile having an associated full text jobs index, comprising the steps of:
comparing a plurality of candidate profiles with a job profile to determine one or more matches;
determining, for the or each candidate profile matched with the job profile, the degree of matching between the full text jobs index and the respective candidate full text digest; and
providing information relating to at least one candidate profile matched to the job profile together with information relating to the degree of matching.

14. The method as claimed in claim 13 further comprising: the step of receiving people search information; and the step of extracting data included in a job profile therefrom.

15. The method as claimed in claim 14 further comprising the step of generating an associated full text jobs index based on the people search information.

16. The method as claimed in claim 13 further comprising the step of generating a full text jobs index based on the job profile.

17. The method as claimed in claim 13 further comprising the step of generating a candidate full text digest based on the candidate profile.

18. The method as claimed in claim 13 further comprising the step of ordering the matched candidate profiles by degree of matching.

19. The method as claimed in claim 18, wherein the step of providing information relating to the matched candidates comprises providing the matched candidates ordered in accordance with the degree of matching.

20. The method as claimed in claim 13 wherein the step of providing information comprises the step of displaying information on a display.

21. The method as claimed in claim 13 further comprising the step of referring a job profile and/or a candidate profile used in or resulting from the method as claimed in claim 13 to at least one social network contact.

22. The method as claimed in claim 13 wherein the job profile includes factual job data.

23. The method as claimed in claim 13 where the candidate profile includes factual job data regarding a desired prospective job.

24. A computer program product residing on a computer readable medium having a plurality of instructions stored thereon which, when executed by a processor, cause the processor to perform operations comprising the method as claimed in claim 13.
